(19) United States
(12) Patent Application Publication
(10) Pub. No.: US 2005/0182832 A1
(43) Pub. Date: Aug. 18, 2005

(54) System and method for graphically managing a stack of network devices

(75) Inventor: Yi-Chien Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/977,722

(22) Filed: Oct. 29, 2004

(30) Foreign Application Priority Data
Feb. 13, 2004 (TW) 93103450

(51) Int. Cl. G06F 15/173; G06F 15/16

(52) U.S. Cl. 709/223; 709/227; 709/203

(57) ABSTRACT

A system for graphically managing a stack of network devices includes a data retrieving module (10) for retrieving data from the network devices in the stack, a data center (20) for storing the data on the network devices in the stack (70), a device panel (30) for displaying status data on the network devices in the stack, a menu library (40) for providing sub-menus to make the system display relevant status data, an event bar (50) for showing a current data change event that occurred in the network devices in the stack, and a timer (60) for controlling the data retrieving module to query the current status data periodically. A related method for graphically managing a stack of network devices is also provided.

### BACKGROUND OF THE INVENTION

1. Field of the Invention

The present invention relates to systems and methods for managing network devices, and particularly relates to a system and method for graphically managing network devices in a stack.

2. Description of Prior Art

With the fast development and widespread application of electronic communication networks, it is becoming more and more important to efficiently and effectively manage network devices employed in the electronic communication networks. A traditional means to manage the network devices is to observe and control them at their individual locations. However, this solution is rather inconvenient and inefficient for the manager or managers involved.

Nowadays most network devices are managed remotely over an electronic communication network. Data on the network devices are displayed in a graphical manner at a control center. For example, U.S. Pat. No. 5,801,707 issued on Sep. 1, 1998 provides an object shown on a display device by way of a three-dimensional perspective view. Referring to FIG. 6, the display device 80 shows a displayed object 90, which preferably has a three-dimensional shape. A plurality of network devices 92, 94, 96 are each represented by different regions on the surface of the displayed object 90. In addition, relationships between the network devices 92, 94, 96 may be shown on the displayed object 90. For example, higher level network devices 92 are displayed on an inner region of the displayed object 90. Although the displayed object 90 is shown to be stationary, it is contemplated that the displayed object may be rotated in any direction by the command of an operator, such that the operator may view the entire surface of the displayed object 90. In this manner, a greater number of network devices and their associated relationships with other network devices may be quickly seen at a high level. Furthermore, information associated with each network device may be displayed on the surface of the displayed object 90. For example, a status indicator applicable to all the network devices may be shown on the surface region of each network device, with each kind of status being displayed using a corresponding color code. In particular, an out of service network device may be shown in red, an in service network device may be shown in blue, and a device that has not yet been allocated on the network may be shown in green. Another method of displaying information regarding each network device is to use a flashing portion of the surface region to indicate an alarm status.

Although the above-mentioned apparatus displays hierarchical data on the network devices, the perspective three-dimensional view is somewhat cryptic to common users. In addition, the perspective three-dimensional view does not display status data on each of the network devices in detail, particularly those network devices in a stack. Accordingly, there is a need for a system and method to graphically display the status data on the network devices intuitively.

### SUMMARY OF THE INVENTION

A first objective of the present invention is to provide a system for graphically managing a stack of network devices conveniently.

A second objective of the present invention is to provide a method for graphically managing a stack of network devices conveniently.

In order to fulfill the above-mentioned first objective, the present invention provides a system for graphically managing network devices in a stack. The system comprises: a data retrieving module for retrieving data from the network devices in the stack; a data center for storing the data on the network devices in the stack; a device panel for displaying status data on the network devices in the stack; a menu library for providing sub-menus to make the system display relevant status data; an event bar for showing a current data change event that occurred in the network devices in the stack; and a timer for controlling the data retrieving module to query the status data periodically.

In order to fulfill the above-mentioned second objective, a method for graphically managing network devices in a stack is provided. The method includes the steps of: connecting to a master network device in the stack, and entering an initiation phase; retrieving attribute data on the network devices of the stack, and sending the attribute data to an attribute data module; saving the attribute data, and configuring an attribute data table; setting device front panels according to the attribute data table; starting a timer; sending a command to query current status data on or before expiry of the timer; retrieving the current status data according to the command, and sending the current status data to a status data module; comparing the sent data of the previous step with current recorded status data, and determining whether the status data have been changed; sending a data change event if the status data have been changed; and restarting the timer.

Other objects, advantages and novel features of the present invention becomes more apparent from the following detailed description when taken in conjunction with the accompanying drawings, in which:

### BRIEF DESCRIPTION OF THE DRAWINGS

FIG. 1 is a functional block diagram of a system for graphically managing a stack of network devices according to a preferred embodiment of the present invention;

FIG. 2 is a flow chart of a data retrieving module of the system of FIG. 1 retrieving data;

FIG. 3 is a flow chart of updating an event bar of the system of FIG. 1;

FIG. 4 is a flow chart of automatically updating device front panels of the system of FIG. 1;

FIG. 5 is a flow chart of updating the device front panels of the system of FIG. 1 when a user alters LED (light emitting diode) modes; and

FIG. 6 is a composite diagram of an object shown on a display device by way of a three-dimensional perspective view, in accordance with prior art.

### DETAILED DESCRIPTION OF THE INVENTION

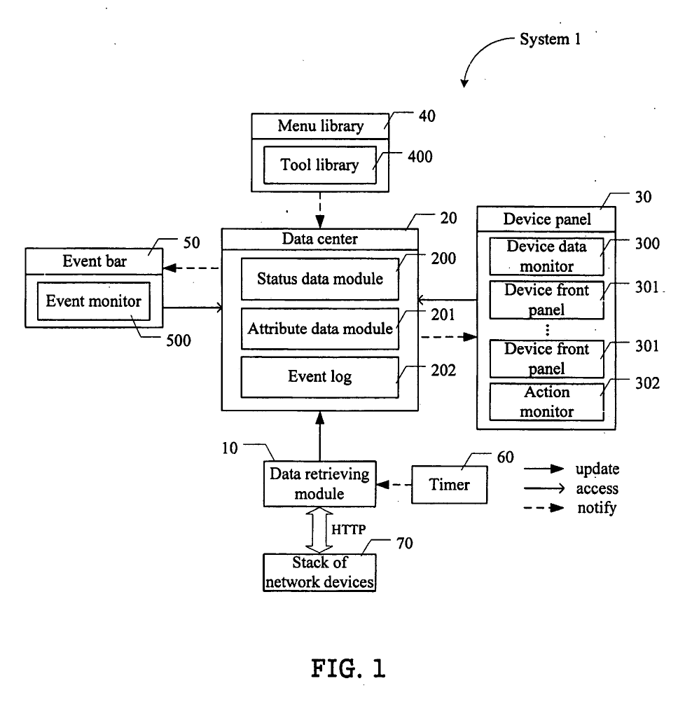

FIG. 1 is a structural and functional block diagram of a system 1 for graphically managing network devices in a stack 70 of network devices, according to the preferred embodiment of the present invention. The system 1 runs on Java Runtime Environment version 1.3.1 or higher, and retrieves data on the network devices in the stack 70 over a communication network. In the preferred embodiment, the stack 70 comprises a master network device and a plurality of slave network devices, and the communication network is the Internet. The system 1 comprises a data retrieving module 10, a data center 20, a device panel 30, a menu library 40, an event bar 50, and a timer 60. The data retrieving module 10 is provided for retrieving data from the network devices in the stack 70 over the Internet, and for sending the data to the data center 20. In the preferred embodiment, the retrieved data include attribute data and status data. The attribute data include unit IDs and model numbers of all network devices in the stack 70, and data on relationships between the network devices. When the system 1 connects to the master network device in the stack 70 and enters an initiation phase, the data retrieving module 10 retrieves the attribute data on all network devices in the stack 70 according to a sole IP (Internet Protocol) address of the master network device in the stack 70, and sends the retrieved attribute data to the data center 20. In the preferred embodiment, because the attribute data retrieved from the network devices in the stack 70 in the initiation phase are unchangeable, the data retrieving module 10 does not query the attribute data after the initiation phase is over. After the initiation phase is over, the data retrieving module 10 is controlled by the timer 60 to query the status data on the network devices in the stack 70. When the timer 60 expiries, the data retrieving module 10 automatically queries current status data on the network devices in the stack 70, and then sends the status data to the data center 20. Then the timer 60 restarts.

The data center 20 comprises a status data module 200, an attribute data module 201, and an event log 202, and is used for storing the data on the network devices in the stack 70. In the preferred embodiment, the data on the network devices in the stack 70 include the attribute data and the status data. The status data module 200 comprises many device data modules, each of which corresponds to a respective one of the network devices in the stack 70 and stores the status data on the corresponding network device. As soon as the status data module 200 receives the status data sent by the data retrieving module 10, the status data module 200 compares the received status data with current recorded status data, and determines whether the status data on the network devices have been changed. If the status data have been changed, the status data module 200 sends a data change event to the event log 202 and to the device panel 30 immediately. The data change event logs that the status data on the network devices in the stack 70 are changed. The attribute data module 201 is used for storing the attribute data, and comprises an attribute data table. In the initiation phase, the attribute data module 201 configures the attribute data table according to the attribute data sent by the data retrieving module 10. In the preferred embodiment, because the attribute data retrieved from the network devices in the stack 70 in the initiation phase are unchangeable, the attribute data table is unchangeable, unless the network devices in the stack 70 are changed. The event log 202 is used for storing data change events that occurred in the network devices in the stack 70. If the event log 202 receives a data change event sent by the status data module 200, the event log 202 saves the data change event that occurred in the network devices in the stack 70, and then sends an event notification to the event bar 50. The event notification indicates that there is a new data change event stored in the event log 202.

The device panel 30 is provided for graphically displaying the status data on the network devices in the stack 70. The device panel 30 includes a device data monitor 300, a plurality of device front panels 301, and an action monitor 302. The device data monitor 300 is used for monitoring and processing the data change events sent by the status data module 200. The device data monitor 300 monitors if there is a data change event sent to the device panel 30. If the device data monitor 300 detects a data change event, the device data monitor 300 retrieves current status data from the status data module 200, and sends the current status data to the device front panels 301. The device front panels 301 are configured in the initiation phase by the attribute data module 201 according to the attribute data table. The device front panels 301 are used for displaying the status data on the network devices in the stack 70, and correspond to respective network devices. The status data on each of the network devices, which are supplied by the status data module 200, can be displayed graphically on the individual device front panels 301 thereof. As soon as the device front panels 301 receive the status data sent by the device data monitor 300, the device front panels 301 display the new status data. The action monitor 302 is employed for monitoring and processing action events sent by LED (light emitting diode) mode buttons. The LED mode buttons are configured on the device front panels 301, and are used to alter LED modes of the network devices in the stack 70. The action events log when the LED mode buttons are touched by a user to alter the LED modes. If the action monitor 302 detects an action event, the action monitor 302 sends an altering command to the status data module 200.

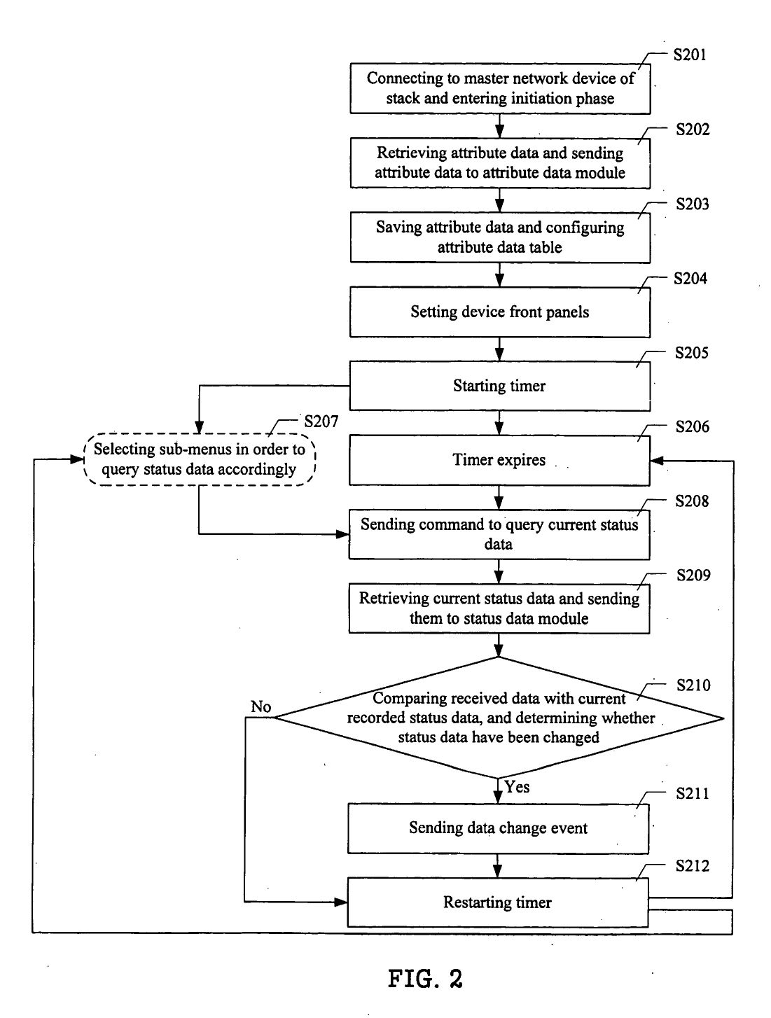

The menu library 40 is a container of three menus: System, View, and Port. Each of the menus comprises several sub-menus. For example, the Port menu comprises the following sub-menus: mirroring, aggregation, VLAN, and 802.1x. When one sub-menu is selected, the system 1 acts responsively and the device front panels 301 display the corresponding information. More details are provided hereinbelow in relation to FIGS. 2 and 4. A tool library 400 is provided in the menu library 40. The tool library 400 contains shortcuts for some sub-menus in the menu library 40.

The event bar 50 is used for notifying a user in real time of the occurrence of a current data change event in the network devices in the stack 70. If a “floating/un-floating” sub-menu in the menu library 40 displays a current selection “un-floating”, the event bar 50 only shows the current data change event that occurred in the network devices in the stack 70. If the “floating/un-floating” sub-menu in the menu library 40 displays a current selection “floating”, the event bar 50 switches to a message list table, and shows previous data change events in addition to the current data change event. In the preferred embodiment of the present invention, the message list table can show the most recent 100 data change events that occurred. The event bar 50 further comprises an event monitor 500, which is used for processing the event notification sent by the event log 202. As soon as the event monitor 500 receives the event notification, the event monitor 500 retrieves the new data change event from the event log 202. Then the event bar 50 displays the new data change event.

FIG. 2 is a flow chart of the data retrieving module 10 retrieving data on the network devices in the stack 70 and sending the retrieved data to the data center 20. In the preferred embodiment of the present invention, the data on the network devices comprise the attribute data and the status data. In accordance with the preferred embodiment, at step S201, the system 1 connects to the master network device of the stack 70 and enters the initiation phase. At step S202, the data retrieving module 10 retrieves the attribute data on the network devices in the stack 70 according to the sole IP address of the master network device, and sends the retrieved attribute data to the attribute data module 201 in the data center 20. At step S203, the attribute data module 201 saves the attribute data, and configures the attribute data table according to the attribute data.

22 At step S204, the attribute data module 201 sets the device front panels 301 according to the attribute data table in the attribute data module 201. At step S205, the timer 60 is started. After a predetermined time period, at step S206, the timer 60 expires automatically. In another embodiment of the present invention, step S206 can be supplemented or replaced by step S207. At step S207, if a user wants to know the status data on the network devices in the stack 70 anytime before the timer 60 expires, he or she can select the sub-menus in the menu library 40 or the tool library 400 in order to query the status data accordingly.

At step S208, the data retrieving module 20 sends a command to the network devices in the stack 70 to query the current status data on the network devices. In the preferred embodiment, the command is as follows: http://<device_ip>/gdm/device?<param1>,<param2>. If a value of the variable “<param1>” is “0,” this represents that the data retrieving module 10 retrieves regular data; if the value is “1,” this represents that the data retrieving module 10 retrieves the regular data and mirroring data; if the value is “2,” this represents that the retrieving data module 10 retrieves the regular data and aggregation data; if the value is “4,” this represents that the data retrieving module 10 retrieves the regular data and 802.1x data; and if the value is “8,” this represents that the data retrieving module 10 retrieves the regular data and VLAN data. If the value of the variable “<param2>” is “<vlan_id>,” this represents that the VLAN data must be retrieved. In the preferred embodiment, the regular data, the mirroring data, the aggregation data, the 802.1x data, and the VLAN data compose the status data on the network devices in the stack 70. The regular data comprise port status data, link data, speed data, and duplex data. The mirroring data show all of mirroring port pairs, and the mirroring port pairs denote source port and destination port settings on the network devices. The aggregation data show all port aggregation groups. The VLAN data show all VLAN IDs and members of one VLAN. The 802.1x data show ports that support the 802.1x standard.

At step S209, the data retrieving module 10 retrieves the current status data according to the command, and sends the current status data to the status data module 200 in the data center 20. At step S210, as soon as the status data module 200 receives the current status data sent by the data retrieving module 10, the status data module 200 compares the received status data with current recorded status data, and determines whether the status data have been changed. If the status data have not been changed, the procedure goes directly to step S212 described below. If the status data have been changed, at step S211, the status data module 200 sends a data change event to the event log 202 in the data center 20 and to the device data monitor 300 in the device panel 30. The data change event logs that the status data on the network devices in the stack 70 are changed. At step S212, the timer 60 is restarted. If required, the predetermined time period can be altered at this step. In the preferred embodiment, the predetermined time period is 3 seconds. Then the procedure returns to step S206 and/or step 207.

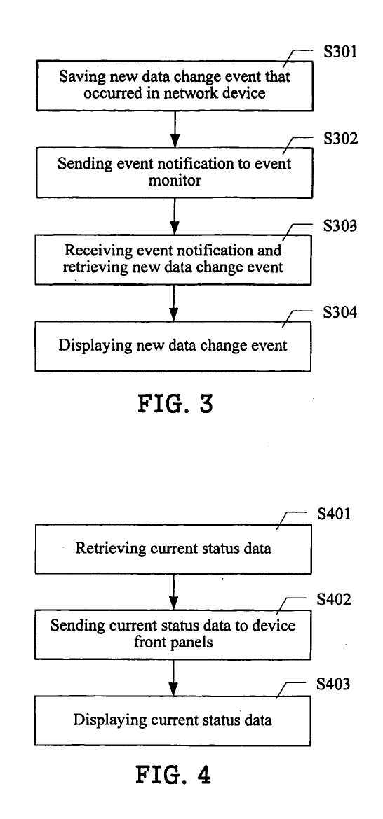

FIG. 3 is a flow chart of updating the event bar 50 after the status data module 200 sends the data change event to the event log 202 and to the device data monitor 300. At step S301, as soon as the event log 202 receives the data change event, the event log 202 saves the new data change event that occurred in the network devices in the stack 70. The new data change event logs that the status data on the network devices are changed. At step S302, the event log 202 sends the event notification to the event monitor 500 in the event bar 50. The event notification indicates that there is a new data change event stored in the event log 202. At step S303, the event monitor 500 receives the event notification, and retrieves the new data change event from the event log 202. At step S304, the event bar 50 displays the new event.

FIG. 4 is a flow chart of automatically updating the device front panels 301 after the status data module 200 sends the data change event to the event log 202 and to the device data monitor 300. At step S401, as soon as the device data monitor 300 receives the data change event, the device data monitor 300 retrieves the current status data from the status data module 200. At step S402, the device data monitor 300 sends the current status data to the device front panels 301. At step S403, the device front panels 301 display the current status data.

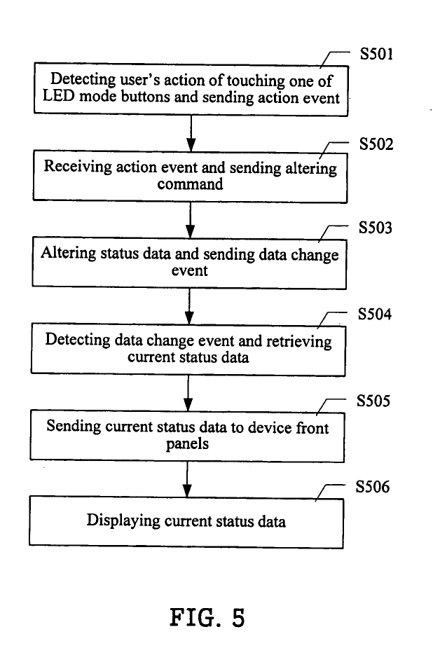

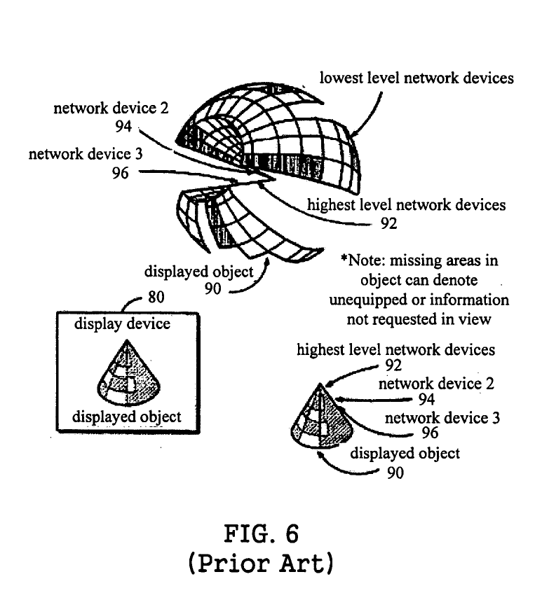

FIG. 5 is a flow chart of updating the device front panels 301 when the user alters LED modes. In the preferred embodiment, at step S501, the LED mode buttons on the device front panels 301 detect the user's action of touching one of the LED mode buttons, and send an action event. At step S502, as soon as the action monitor 302 receives the action event, the action monitor 302 sends an altering command to the status data module 200. At step S503, the status data module 200 alters the status data according to the altering command, and sends the data change event to the device data monitor 300. At step S504, the device data monitor 300 detects the data change event, and retrieves current status data from the status data module 200. At step S505, the device data monitor 300 sends the current status data to the device front panels 301. At step S506, the device front panels 301 display the current status data.

While preferred embodiments and methods of the present invention have been described above, it should be understood that they have been presented by way of example only and not by way of limitation. Thus the breadth and scope of the present invention should not be limited by the above-described exemplary embodiments and methods, but should be defined only in accordance with the following claims and their equivalents.

1. A system for graphically managing a stack of network devices, retrieving status data and attribute data on the network devices in the stack over a communication network, and displaying the status data in a graphical manner, comprising:
a data retrieving module, for retrieving the status data and the attribute data from the network devices in the stack;
a data center, for storing the status data and the attribute data on the network devices in the stack;
a device panel, for displaying the status data of the network devices in the stack;
a menu library, for providing sub-menus to make the system display relevant status data;
an event bar, for showing a current data change event that occurred in the network devices in the stack; and
a timer for controlling the data retrieving module to query the status data on the network devices in the stack periodically;
wherein the stack of the networks devices comprises a master network device and a plurality of slave network devices.

2. The system as recited in claim 1, wherein the data center comprises:
a status data module for storing the status data;
an attribute data module for storing the attribute data on the network devices in the stack; and
an event log for storing data change events that occurred in the network devices in the stack.

3. The system as recited in claim 2, wherein the attribute data are retrieved by the data retrieving module, according to a sole IP (Internet Protocol) address of the master network device of the stack in an initiation phase, and are unchangeable

4. The system as recited in claim 1, wherein the event bar can switch to a message list table in order to display a historical list of data change events that occurred in the network devices in the stack.

5. The system as recited in claim 4, wherein the event bar switches to the message list table by a user's selection of a “floating/un-floating” sub-menu in the menu library.

6. The system as recited in claim 1, wherein the device panel comprises a plurality of device front panels that correspond to respective network devices in order to display corresponding status data.

7. A method for graphically managing a stack of network devices, comprising the steps of:
connecting to a master network device of the stack and entering an initiation phase;
retrieving attribute data and sending the attribute data to an attribute data module;
saving the attribute data and configuring an attribute data table according to the attribute data;
setting device front panels according to the attribute data table;
starting a timer;
sending a command to query current status data on or before expiry of the timer;
retrieving the current status data, and sending the current status data to a status data module;
comparing the sent data of the previous step with current recorded status data, and determining whether the status data have been changed;
sending a data change event if the status data have been changed; and
restarting the timer.

8. The method as recited in claim 7, further comprising the step of updating an event bar after the step of sending the data change event, if the status data have been changed.

9. The method as recited in claim 7, further comprising the step of updating the device front panels after the step of sending the data change event, if the status data have been changed.

10. The method as recited in claim 8, wherein the step of updating the event bar comprises the steps of:
saving a new data change event that occurred in the network devices in the stack;
sending an event notification to an event monitor;
receiving the event notification, and retrieving the new data change event; and
displaying the new data change event.

11. The method as recited in claim 9, wherein the step of updating the device front panels comprises the steps of:
retrieving the current status data;
sending the current status data to the device front panels; and
displaying the current status data.

12. The method as recited in claim 9, wherein the step of updating the device front panels comprises the steps of:
detecting a user's action of touching one of LED (light emitting diode) mode buttons, and sending an action event;
receiving the action event, and sending an altering command;
altering the status data according to the altering command, and sending the data change event;
detecting the data change event, and retrieving the current status data;
sending the current status data to the device front panels; and
displaying the current status data.

13. A method for graphically managing network devices, comprising the steps of:
retrieving attribute data of said network devices;
displaying graphically said network devices by means of a corresponding number of stacked device panels based on said attribute data of said network devices;
retrieving periodically status data of each of said network devices; and
displaying said status data of said each network device by means of a corresponding device panel of said each network device.

14. The method as recited in claim 13, further comprising recording changes of said status data of said each network device in case that a new one of said status data is retrieved in said retrieving step.
